(19) United States
(12) Patent Application Publication
(10) Pub. No.: US 2018/0350399 A1
(43) Pub. Date: Dec. 6, 2018

(54) HEAT ASSISTED MAGNETIC RECORDING MEDIA WITH CO-BASED ALLOY

(71) Applicant: Seagate Technology LLC, Cupertino, CA (US)

(72) Inventors: Antonio Javier ZAMBANO, San Jose, CA (US); ZhaoHui FAN, Fremont, CA (US); Xiaoding MA, Fremont, CA (US); Connie Chunling LIU, San Jose, CA (US); Jerry Kueirweei CHOUR, Fremont, CA (US)

(21) Appl. No.: 15/615,773

(22) Filed: Jun. 6, 2017

(51) Int. Cl. G11B 5/706; G11B 5/84; G11B 5/73; G11B 5/65

(52) U.S. Cl. CPC G11B 5/70673; G11B 5/8404; G11B 5/656; G11B 5/70621; G11B 5/73

(57) ABSTRACT

An apparatus is disclosed. The apparatus includes a storage layer and a write layer. The storage layer is magnetic and has an L1₀ crystalline structure. The write layer is directly disposed over the storage layer. The write layer is magnetic and has a crystalline structure that is different from the L1₀ crystalline structure of the storage layer.

### BACKGROUND

Certain devices use disk drives with heat assisted magnetic recording (HAMR) media to store information. For example, disk drives can be found in many desktop computers, laptop computers, and data centers. HAMR media store information magnetically as bits. In HAMR, generally FePt magnetic layers are used in order to increase magnetic moment of the system. However, roughness is also increased because of high temperature needed to grow the L1₀ lattice structure of FePt.

### SUMMARY

Accordingly, a need has arisen to increase magnetic moment of the system while maintaining the roughness in the acceptable range. Provided herein is an apparatus that increases the magnetic moment of the system while it minimizes the resulting roughness in a HAMR media. The apparatus includes a storage layer and a write layer. The storage layer is magnetic and has an L1₀ crystalline structure. The write layer is directly disposed over the storage layer. The write layer is magnetic and has a crystalline structure that is different from the L1₀ crystalline structure of the storage layer.

These and other features and advantages will be apparent from a reading of the following detailed description.

### BRIEF DESCRIPTION OF DRAWINGS

FIGS. 1A-1D show a heat assisted magnetic recording (HAMR) media according to one aspect of the present embodiments.

FIGS. 2A-2E show the HAMR media including break layers according to one aspect of the present embodiments.

FIG. 3 shows an illustrative flow diagram for manufacturing the HAMR according to one aspect of the present embodiments.

### DESCRIPTION

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “middle,” “bottom,” “beside,” “forward,” “reverse,” “overlying,” “underlying,” “up,” “down,” or other similar terms such as “upper,” “lower,” “above,” “below,” “under,” “between,” “over,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

It is understood heat assisted magnetic recording (HAMR) media may include both granular magnetic layers and continuous magnetic layers. Granular layers include grains that are segregated in order to physically and magnetically decouple the grains from one another. Segregation of the grains may be done, for example, with formation of segregants such as oxides, carbon (C), boron (B), boron nitride (BN), etc., at the boundaries between adjacent magnetic grains. As such, the segregated magnetic grains form a granular layer. When multiple granular layers stacked together they form a columnar structure, where the magnetic alloys are hetero-epitaxially grown into columns while the oxides segregate into grain (column) boundaries. HAMR media may include both granular layers and continuous layers.

Increasing magnetic moment in a HAMR media is desirable without losing coercivity. As such, conventionally L1₀ lattice structure of FePt is used to increase the magnetic moment of the system. Unfortunately, due to the high temperature used to grow the FePt layers, roughness of the system is increased as well. In order to increase the magnetic moment without losing coercivity while minimally impacting roughness, a CoPt based alloy or a CoFePt based alloy (also referred to as the write layer) is used in addition to using the FePt layer (also referred to as the storage layer). For example, the CoPt based alloy or the CoFePt based alloy may be deposited over the FePt layer. It is appreciated that although CoPt based alloy or the CoFePt alloy have a different lattice structure than FePt layer, nonetheless, they can grow on the FePt layer and maintain the granular structure of the FePt layer. Furthermore, CoPt based alloy or CoFePt based alloy can grow on the FePt layer at a much lower temperature than used to grow the FePt layer, thereby minimally impacting the roughness while increasing the magnetic moment of the system. Therefore, electrical performance such as signal amplitude, equalized signal to noise ratio, direct current (DC) equalized signal to noise ratio, etc., is also enhanced.

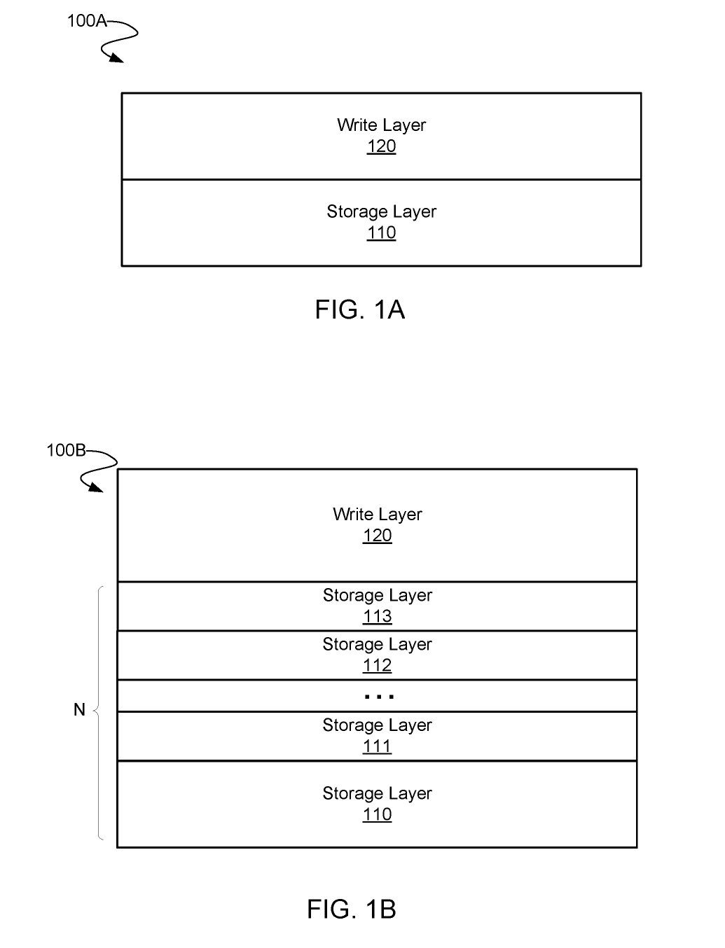

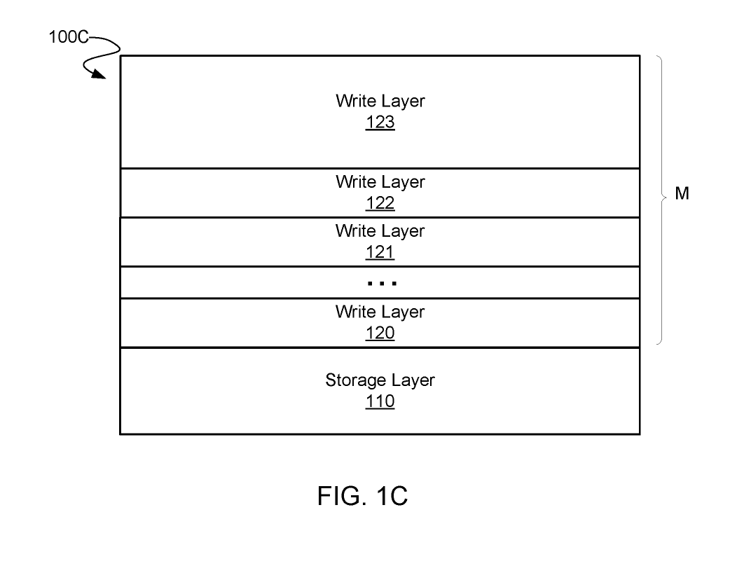

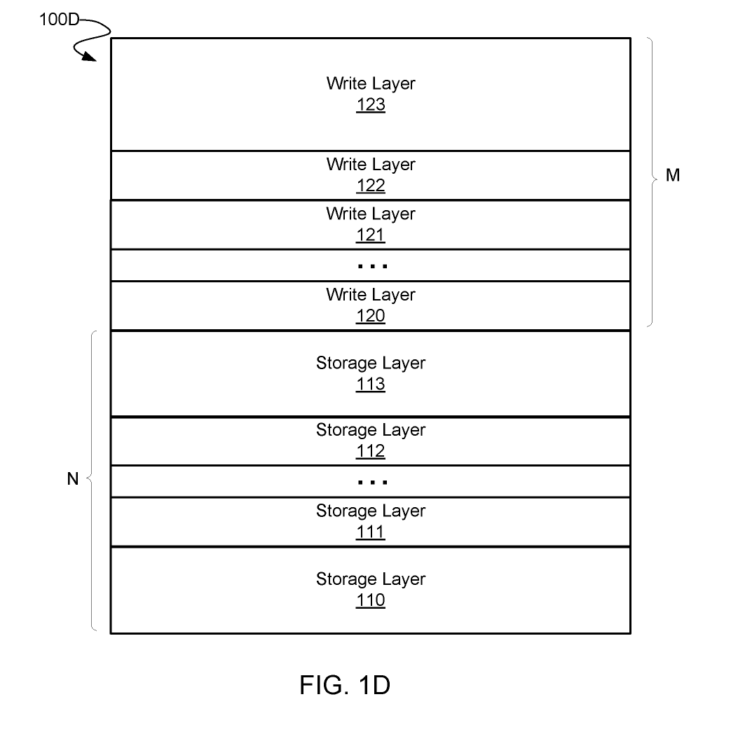

FIGS. 1A-1D show a HAMR media according to one aspect of the present embodiments. Referring specifically to FIG. 1A, a HAMR media 100A is shown. The HAMR media 100A includes a storage layer 110 and a write layer 120 disposed directly over the storage layer 110.

It is appreciated that the lattice structure of the storage layer 110 is different from the lattice structure of the write layer 120. However, it is appreciated that the write layer 120 may nonetheless follow the orientation of the storage layer 110 as it is grown over the storage layer 110.

In some embodiments the storage layer 110 may include material such as FePt, FePtCu, FePtAg, FePtCuAg, FePtMo, FePtCo, FePtNi, FeCoPt, CoPdPt, etc., to name a few. It is appreciated that in some embodiments, the storage layer 110 may have L1₀ lattice structure, e.g., as in FePt structure. In some embodiments, the storage layer 110 such as FePt may include substantially the same amount of Fe as Pt.

It is appreciated that in some embodiments, the write layer 120 may include material such as CoPtX and/or CoFePtX where X is Ta, B, Mo, Si, Cu, Ag, Au, Ge, Hf, Zr, Ti, V, W, Fe, Ni, Cr, Oxide, Ru, etc. It is appreciated that the write layer 120 has a lattice structure other than L1₀ lattice structure, e.g., a face-centered cub (fcc), hexagonal close packing (hcp), body centered cubic (bcc), etc. Moreover, it is appreciated that the write layer 120 has perpendicular uniaxial anisotropy when it is directly deposited over the storage layer 110. In some embodiments, the write layer 120 may include between 0 to 25% Pt and more than 30% Co. In some embodiments the write layer 120 may include Co_{100-x-y-z-δ-α-β}PtₓCr_{y}B_{z}Ta_{δ}Zr_{β}Ag_{α} where x>30%, 0≤y≤30%, 0≤z≤30%, 0≤δ≤8%, 0≤α≤8%, 0≤β≤8%, and α+β≥0.

It is further appreciated that each of the storage layer 110 may further include segregants. For example, segregants may include material such as B, C, SiC, BC, TiC, TaC, BN, SiN, TiN, SiO₂, B₂O₃, WO₃, Ta₂O₅, TiO₂, etc. In some embodiments, the write layer 120 may further include segregants. For example, segregants may include material such as B, C, SiC, BC, TiC, TaC, BN, SiN, TiN, SiO₂, B₂O₃, WO₃, Ta₂O₅, TiO₂, etc.

It is appreciated that the write layer 120 may be a continuous layer or one or more granular layers. It is appreciated that the storage layer 110 may be a continuous layer or one or more granular layers.

It is appreciated that in order to grow the storage layer 110, e.g., FePt, a very high temperature is used, e.g., 500° C. However, it is further appreciated that in order to grow the write layer 120, e.g., CoPt or an alloy thereof, CoFePt or an alloy thereof, etc., on the storage layer 110, a substantially lower temperature is used, e.g., less than 450° C. Thus, the roughness of the system is not increased while the magnetic moment of the system is desirably increased. It is also appreciated that using the write layer 120 such as CoPt or an alloy thereof, or CoFePt or an alloy thereof increases corrosion resistance of the HAMR media.

Referring now to FIG. 1B, a HAMR 100B according to one aspect of the present embodiments is shown. The HAMR 100B is substantially similar to that of 100A of FIG. 1A. However, the storage layer 110 may include multiple storage layers, e.g., N storage layers. In this embodiment, the HAMR media 100B includes storage layers 110, 111, . . . , 112, and 113. In some embodiments, the storage layers 110, 111, . . . , 112, and 113 include material such as FePt, FePtCu, FePtAg, FePtCuAg, FePtMo, FePtCo, FePtNi, FeCoPt, CoPdPt, etc., to name a few. It is appreciated that in some embodiments, the storage layers 110, 111, . . . , 112, and 113 may have L1₀ lattice structure, e.g., as in FePt structure. In some embodiments, the storage layers 110, 111, . . . , 112, and 113 such as FePt may include substantially the same amount of Fe as Pt. It is further appreciated that each of the storage layers 110, 111, . . . , 112, and 113 may further include segregants. For example, segregants may include material such as B, C, SiC, BC, TiC, TaC, BN, SiN, TiN, SiO₂, B₂O₃, WO₃, Ta₂O₅, TiO₂, etc.

It is appreciated that similar to the HAMR media 100A, the write layer 120 of HAMR media 100B is directly deposited over the upper most storage layer, e.g., storage layer 113. As such, the write layer 120 follows the orientation of the storage layer 113 when deposited. Moreover, as described above, the write layer 120 may be grown at substantially lower temperature in comparison to the storage layers, therefore minimizing the impact on the roughness while increasing the magnetic moment of the system.

Referring now to FIG. 1C, a HAMR 100C according to one aspect of the present embodiments is shown. The HAMR 100C is substantially similar to that of 100A of FIG. 1A. However, the write layer 120 may include multiple write layers, e.g., M write layers. In this embodiment, the HAMR media 100C includes write layers 120, . . . , 121, 122, and 123. In some embodiments, the write layers 120, . . . , 121, 122, and 123 may include material such as CoPtX and/or CoFePtX where X is Ta, B, Mo, Si, Cu, Ag, Au, Ge, Hf, Zr, Ti, V, W, Fe, Ni, Cr, Oxide, Ru, etc. It is appreciated that the write layers 120, . . . , 121, 122, and 123 has a lattice structure other than L1₀ lattice structure of the storage layer 110, e.g., a face-centered cub (fcc), hexagonal close packing (hcp), body centered cubic (bcc), etc. Moreover, it is appreciated that the write layers 120, . . . , 121, 122, and 123 have perpendicular uniaxial anisotropy when directly deposited over the storage layer 110. In some embodiments, the write layers 120, . . . , 121, 122, and 123 may include between 0 to 25% Pt and more than 30% Co. In some embodiments, each of the write layers 120, . . . , 121, 122, and 123 may further include segregants. For example, segregants may include material such as B, C, SiC, BC, TiC, TaC, BN, SiN, TiN, SiO₂, B₂O₃, WO₃, Ta₂O₅, TiO₂, etc. In some embodiments the write layer 120 may include Co_{100-x-y-z-δ-α-β}PtₓCr_{y}B_{z}Ta_{δ}Zr_{β}Ag_{α} where x>30%, 0≤y≤30%, 0≤z≤30%, 0≤δ≤8%, 0≤α≤8%, 0≤β≤8%, and α+β≥0.

It is appreciated that similar to the HAMR media 100A, the write layer 120 of HAMR media 100C is directly deposited over the storage layer 110. As such, the write layer 120 follows the orientation of the storage layer 110 when deposited. Moreover, as described above, the write layer 120 may be grown at substantially lower temperature in comparison to the storage layers, therefore minimizing the impact on the roughness while increasing the magnetic moment of the system.

Referring now to FIG. 1D, a HAMR 100D according to one aspect of the present embodiments is shown. The HAMR 100D is substantially similar to that of 100B and 100C of FIGS. 1B and 1C. In other words, the HAMR 100D media includes multiple write layers, e.g., M write layers, and multiple storage layers, e.g., N storage layers. The HAMR 100D functions similar to that of FIGS. 1B and 1C.

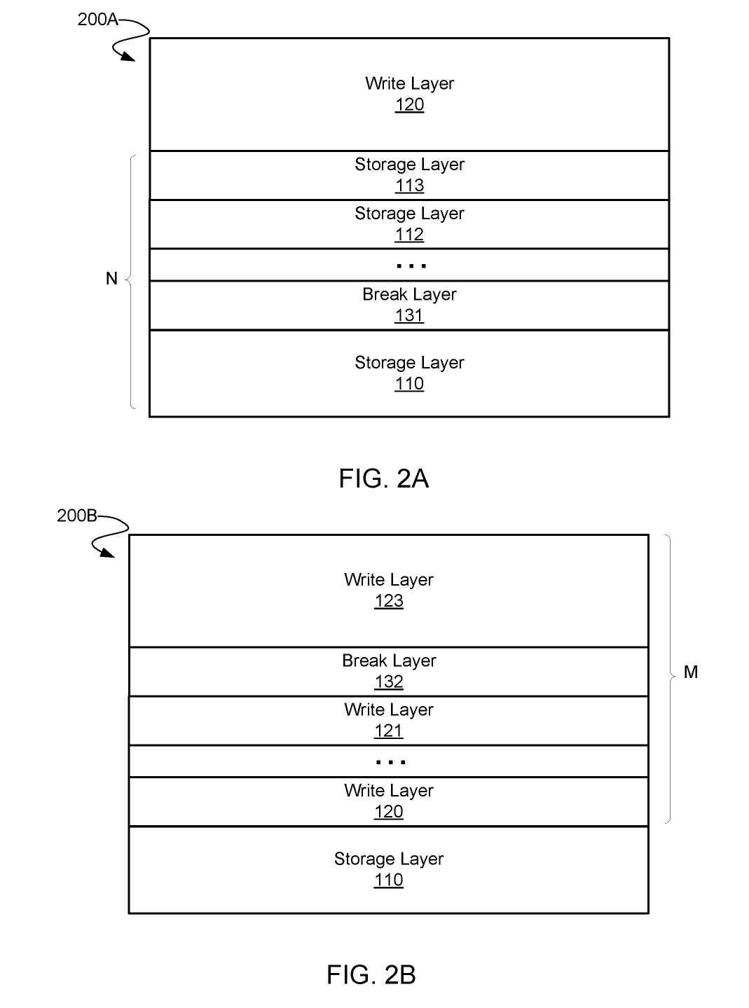

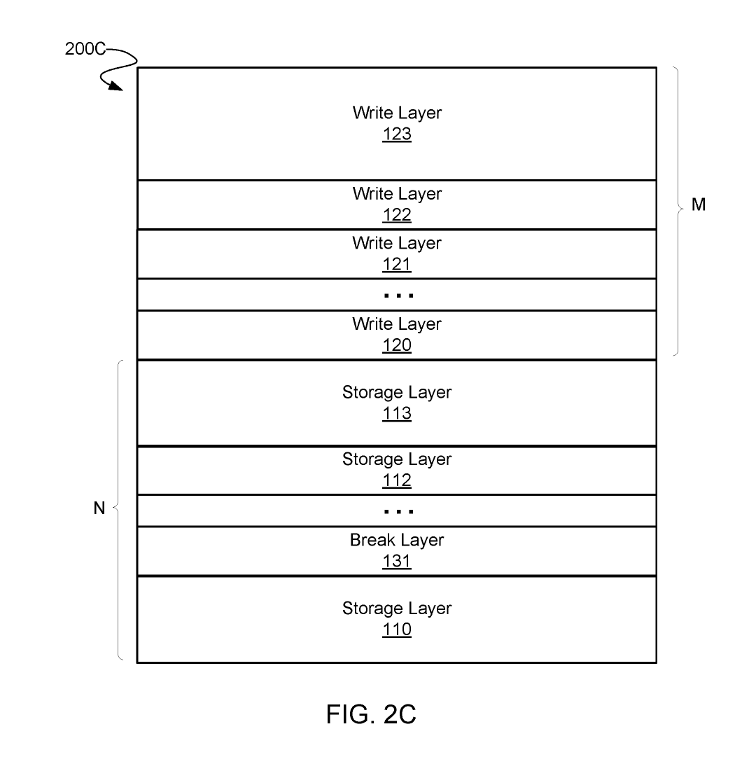

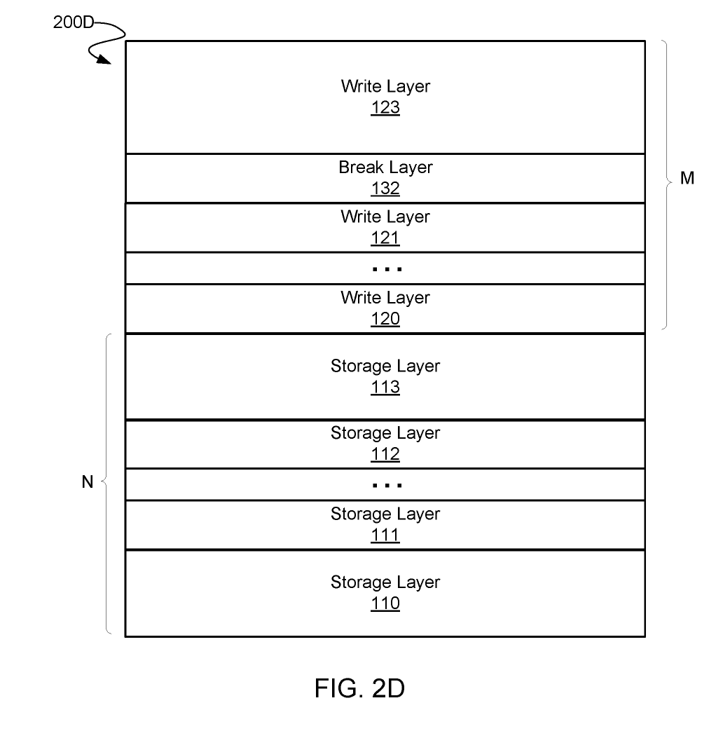

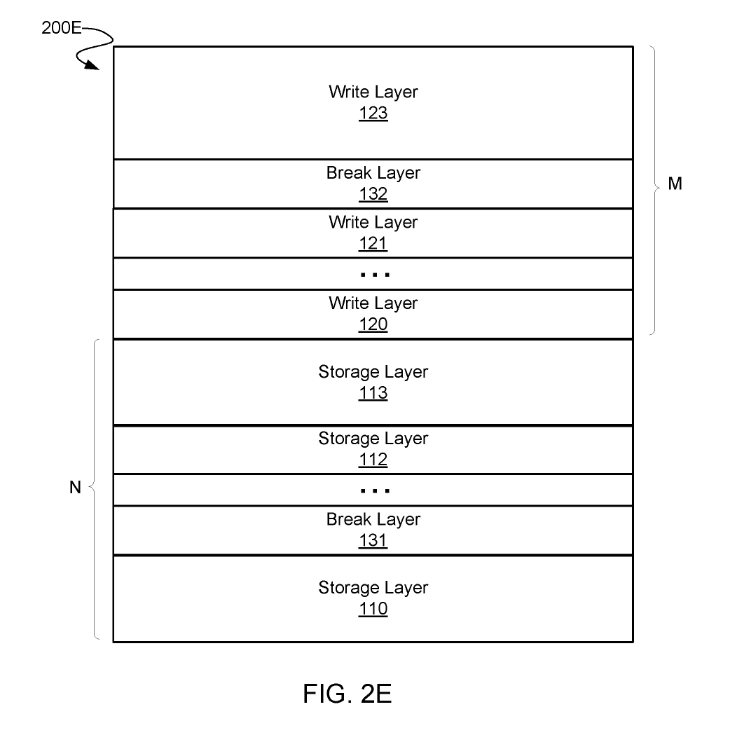

Referring now to FIG. 2A a HAMR media 200A including a break layer according to one aspect of the present embodiments is shown. HAMR media 200A is substantially similar to the HAMR media 100B. However, the HAMR media 200A includes a break layer 131 that separates two storage layers from one another. It is appreciated that even though one break layer 131 separating the storage layer 110 from another storage layer is shown, any number of break layers may be used to separate the storage layers from one another. As such, use of one break layer for illustration purposes should not be construed as limiting the scope of the embodiments.

It is appreciated that the break layer 131 may be magnetic or nonmagnetic. For example, the nonmagnetic break layer 131 may include FeX where X is Co, Cr, Oxide, Nitride, C, B, etc., and where the composition of X is selected such that FeX is nonmagnetic. In some embodiments, the break layers may include FeCoX where X is Cr, Oxide, Nitride, C, B, etc., where the composition of X is selected such that FeCoX is nonmagnetic. It is appreciated that the break layer 131 may be a continuous layer or one or more granular layers. For example, the break layer 131 may include grain decoupling material, e.g., C, carbide such as SiC, BC, TiC, TaC, etc., nitride such as BN, SiN, TiN, TaN, etc., oxide such as SiO2, B2O3, Ta2O5, TiO2, WO3, TaO5, TiO3, etc., or any combination thereof.

Referring now to FIG. 2B a HAMR media 200B including a break layer according to one aspect of the present embodiments is shown. HAMR media 200B is substantially similar to the HAMR media 100C. However, the HAMR media 200B includes a break layer 132 that separates two write layers from one another. For example, the break layer 132 separates the write layer 121 from the write layer 123. It is appreciated that even though one break layer 132 separating the write layers 121 and 123 is shown, any number of break layers may be used to separate the write layers from one another. As such, use of one break layer for illustration purposes should not be construed as limiting the scope of the embodiments.

It is appreciated that the break layer 132 may be magnetic or nonmagnetic. For example, the nonmagnetic break layer 132 may include FeX where X is Co, Cr, Oxide, Nitride, C, B, etc., and where the composition of X is selected such that FeX is nonmagnetic. In some embodiments, the break layers may include FeCoX where X is Cr, Oxide, Nitride, C, B, etc., where the composition of X is selected such that FeCoX is nonmagnetic. It is appreciated that the break layer 132 may be a continuous layer or one or more granular layers. For example, the break layer 132 may include grain decoupling material, e.g., C, carbide such as SiC, BC, TiC, TaC, etc., nitride such as BN, SiN, TiN, TaN, etc., oxide such as SiO2, B2O3, Ta2O5, TiO2, WO3, TaO5, TiO3, etc., or any combination thereof.

Referring now to FIG. 2C a HAMR media 200C including a break layer according to one aspect of the present embodiments is shown. HAMR media 200C is substantially similar to the HAMR media 100D. However, the HAMR media 200C includes a break layer 131 that separates two storage layers from one another. It is appreciated that even though one break layer 131 separating the storage layer 110 from another storage layer is shown, any number of break layers may be used to separate the storage layers from one another. As such, use of one break layer for illustration purposes should not be construed as limiting the scope of the embodiments.

It is appreciated that the break layer 131 may be magnetic or nonmagnetic. For example, the nonmagnetic break layer 131 may include FeX where X is Co, Cr, Oxide, Nitride, C, B, etc., and where the composition of X is selected such that FeX is nonmagnetic. In some embodiments, the break layers may include FeCoX where X is Cr, Oxide, Nitride, C, B, etc., where the composition of X is selected such that FeCoX is nonmagnetic. It is appreciated that the break layer 131 may be a continuous layer or one or more granular layers. For example, the break layer 131 may include grain decoupling material, e.g., C, carbide such as SiC, BC, TiC, TaC, etc., nitride such as BN, SiN, TiN, TaN, etc., oxide such as SiO2, B2O3, Ta2O5, TiO2, WO3, TaO5, TiO3, etc., or any combination thereof.

Referring now to FIG. 2D a HAMR media 200D including a break layer according to one aspect of the present embodiments is shown. HAMR media 200D is substantially similar to the HAMR media 100D. However, the HAMR media 200D includes a break layer 132 that separates two write layers from one another. For example, the break layer 132 separates the write layer 121 from the write layer 123. It is appreciated that even though one break layer 132 separating the write layers 121 and 123 is shown, any number of break layers may be used to separate the write layers from one another. As such, use of one break layer for illustration purposes should not be construed as limiting the scope of the embodiments.

It is appreciated that the break layer 132 may be magnetic or nonmagnetic. For example, the nonmagnetic break layer 132 may include FeX where X is Co, Cr, Oxide, Nitride, C, B, etc., and where the composition of X is selected such that FeX is nonmagnetic. In some embodiments, the break layers may include FeCoX where X is Cr, Oxide, Nitride, C, B, etc., where the composition of X is selected such that FeCoX is nonmagnetic. It is appreciated that the break layer 132 may be a continuous layer or one or more granular layers. For example, the break layer 132 may include grain decoupling material, e.g., C, carbide such as SiC, BC, TiC, TaC, etc., nitride such as BN, SiN, TiN, TaN, etc., oxide such as SiO2, B2O3, Ta2O5, TiO2, WO3, TaO5, TiO3, etc., or any combination thereof.

Referring now to FIG. 2E a HAMR media 200E including a break layer according to one aspect of the present embodiments is shown. HAMR media 200E is substantially similar to the HAMR media 200C and 200D. HAMR media 200E includes the break layers 131 and 132. The break layer 132 separates two write layers from one another and the break layer 131 that separates two storage layers from one another. For example, the break layer 132 separates the write layer 121 from the write layer 123 and the break layer 131 separates the storage layer 110 from other storage layers.

It is appreciated that even though one break layer 132 separating the write layers 121 and 123 is shown, any number of break layers may be used to separate the write layers from one another. It is further appreciated that even though one break layer 131 separating the storage is shown, any number of break layers may be used to separate the storage layers from one another. As such, the number of break layers used is for illustration purposes and should not be construed as limiting the scope of the embodiments.

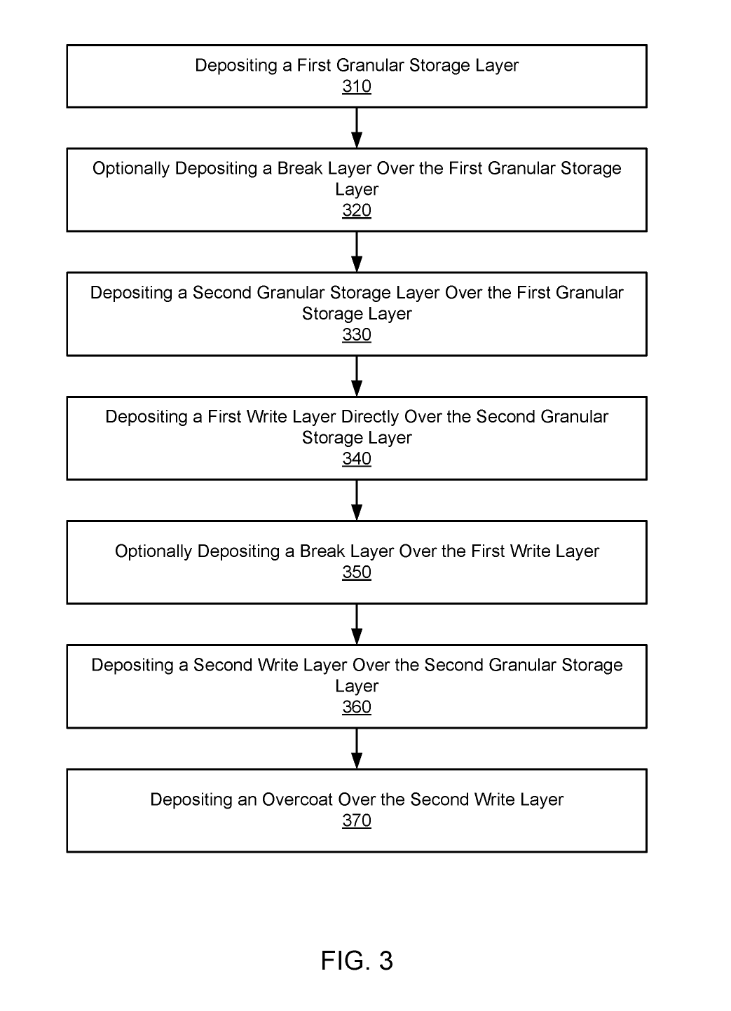

FIG. 3 shows an illustrative flow diagram for manufacturing the HAMR according to one aspect of the present embodiments. At step 310, a first granular storage layer is deposited. For example, FePt may be heated to over 500° C. to grow the structure. The granular storage layer may include material such as FePt, FePtCu, FePtAg, FePtCuAg, FePtMo, FePtCo, FePtNi, FeCoPt, CoPdPt, etc., to name a few. It is appreciated that in some embodiments, the granular storage layer may have L1₀ lattice structure, e.g., as in FePt structure. In some embodiments, the granular storage layer such as FePt may include substantially the same amount of Fe as Pt. It is further appreciated that each of the first granular storage layer may further include segregants. For example, segregants may include material such as B, C, SiC, BC, TiC, TaC, BN, SiN, TiN, SiO₂, B₂O₃, WO₃, Ta₂O₅, TiO₂, etc.

At step 320, optionally a break layer is deposited over the first granular storage layer. It is appreciated that the break layer deposited may be similar to that discussed in FIGS. 2A, 2C, and 2E. At step 330, a second granular storage layer is deposited over the first granular storage layer. For example, in some embodiments, the second granular storage layer is directly deposited over the first granular storage layer and in some embodiments it is deposited directly over the break layer. The second granular storage layer may include material such as FePt, FePtCu, FePtAg, FePtCuAg, FePtMo, FePtCo, FePtNi, FeCoPt, CoPdPt, etc., to name a few. It is appreciated that in some embodiments, the granular storage layer may have L1₀ lattice structure, e.g., as in FePt structure. In some embodiments, the granular storage layer such as FePt may include substantially the same amount of Fe as Pt. It is further appreciated that each of the second granular storage layer may further include segregants. For example, segregants may include material such as B, C, SiC, BC, TiC, TaC, BN, SiN, TiN, SiO₂, B₂O₃, WO₃, Ta₂O₅, TiO₂, etc.

At step 340, a first write layer is directly deposited over the second granular storage layer. The first write layer may include material such as CoPtX and/or CoFePtX where X is Ta, B, Mo, Si, Cu, Ag, Au, Ge, Hf, Zr, Ti, V, W, Fe, Ni, Cr, Oxide, Ru, etc. In some embodiments the first write layer may include Co_{100-x-y-z-δ-α-β}PtₓCr_{y}B_{z}Ta_{δ}Zr_{β}Ag_{α} where x>30%, 0≤y≤30%, 0≤z≤30%, 0≤δ≤8%, 0≤α≤8%, 0≤β≤8%, and α+β≥0. It is appreciated that the first write layer has a lattice structure other than L1₀ lattice structure, e.g., a face-centered cub (fcc), hexagonal close packing (hcp), body centered cubic (bcc), etc. Moreover, it is appreciated that the first write layer has perpendicular uniaxial anisotropy when it is directly deposited over the second granular storage layer. In some embodiments, the first write layer may include between 0 to 25% Pt and more than 30% Co. The first write layer may be deposited at a much lower temperature than the required temperature for growing the granular storage layers. For example, the first write layer may be deposited and grown at a temperature lower than 450° C. In some embodiments, the first write layer may further include segregants. For example, segregants may include material such as B, C, SiC, BC, TiC, TaC, BN, SiN, TiN, SiO₂, B₂O₃, WO₃, Ta₂O₅, TiO₂, etc.

At step 350, optionally a break layer is deposited over the first write layer. It is appreciated that the break layer deposited may be similar to that discussed in FIGS. 2B, 2D, and 2E. At step 360, a second write layer is deposited over the first write layer. For example, in some embodiments, the second write layer is directly deposited over the first write layer and in some embodiments it is deposited directly over the break layer. The second write layer may include material such as CoPtX and/or CoFePtX where X is Ta, B, Mo, Si, Cu, Ag, Au, Ge, Hf, Zr, Ti, V, W, Fe, Ni, Cr, Oxide, Ru, etc. In some embodiments the second write layer may include Co_{100-x-y-z-δ-α-β}PtₓCr_{y}B_{z}Ta_{δ}Zr_{β}Ag_{α} where x>30%, 0≤y≤30%, 0≤z≤30%, 0≤δ≤8%, 0≤α≤8%, 0≤β≤8%, and α+β≥0. It is appreciated that the second write layer has a lattice structure other than L1₀ lattice structure, e.g., a face-centered cub (fcc), hexagonal close packing (hcp), body centered cubic (bcc), etc. Moreover, it is appreciated that the first write layer has perpendicular uniaxial anisotropy when it is directly deposited over the second granular storage layer. In some embodiments, the second write layer may include between 0 to 25% Pt and more than 30% Co. The second write layer may be deposited at a much lower temperature than the required temperature for growing the granular storage layers. For example, the second write layer may be deposited and grown at a temperature lower than 450° C. In some embodiments, the first write layer may further include segregants. For example, segregants may include material such as B, C, SiC, BC, TiC, TaC, BN, SiN, TiN, SiO₂, B₂O₃, WO₃, Ta₂O₅, TiO₂, etc.

In some embodiments, at step 370, an overcoat layer is deposited over the second write layer. The overcoat layer may include carbon, for example.

Accordingly, the write layers are grown at much lower temperature than the storage layers. Thus, the roughness of the system is not increased while the magnetic moment of the system is desirably increased. It is also appreciated that using the write layer such as CoPt or an alloy thereof, or CoFePt or an alloy thereof increases corrosion resistance of the HAMR media. It is appreciated that at least one write layer of HAMR media is directly deposited over the upper most storage layer. As such, the write layer follows the orientation of the storage layer when deposited.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. An apparatus comprising:
a storage layer, wherein the storage layer is magnetic and has an L1₀ crystalline structure; and
a write layer directly disposed over the storage layer, wherein the write layer is magnetic and has a crystalline structure that is different from the L1₀ crystalline structure of the storage layer.

2. The apparatus of claim 1, wherein a material of the storage layer is selected from a group consisting of FePt, FePtCu, FePtAg, FePtCuAg, FePtMo, FePtCo, FePtNi, FeCoPt, and CoPdPt.

3. The apparatus of claim 2, wherein the storage layer comprises a segregant selected from a group consisting of B, C, SiC, BC, TiC, TaC, BN, SiN, TiN, SiO₂, B₂O₃, WO₃, Ta₂O₅, and TiO₂.

4. The apparatus of claim 1, wherein a material of the write layer is selected from a group consisting of CoPtX and CoFePtX, wherein X is selected from a group consisting of Ta, B, Mo, Si, Cu, Ag, Au, Ge, Hf, Zr, Ti, V, W, Fe, Ni, Cr, Oxide, and Ru.

5. The apparatus of claim 4, wherein the write layer comprises a segregant selected from a group consisting of B, C, SiC, BC, TiC, TaC, BN, SiN, TiN, SiO₂, B₂O₃, WO₃, Ta₂O₅, and TiO₂.

6. The apparatus of claim 1, wherein the write layer comprises a CoPt based alloy, wherein Co comprises more than 30% of the CoPt based alloy and wherein Pt comprises greater than 0% and less than 25% of the CoPt based alloy.

7. The apparatus of claim 1, wherein the write layer has a face-centered cubic (fcc) lattice structure.

8. The apparatus of claim 1, wherein the write layer has a hexagonal close packing lattice structure.

9. The apparatus of claim 1, wherein the storage layer and the write layer are layers within a heat assisted magnetic recording (HAMR) media.

10. A heat assisted magnetic recording media comprising:
a plurality of storage layers, wherein the plurality of storage layers is magnetic and has an L1₀ crystalline structure;
a first write layer directly disposed over the plurality of storage layers, wherein the first write layer is magnetic and has a crystalline structure that is different from the L1₀ crystalline structure of the plurality of storage layers; and
a second write layer disposed over the first write layer, wherein the second write layer is magnetic and has a crystalline structure that is different from the L1₀ crystalline structure of the plurality of storage layers.

11. The heat assisted media recording of claim 10, wherein a material of the plurality of storage layers is selected from a group consisting of FePt, FePtCu, FePtAg, FePtCuAg, FePtMo, FePtCo, FePtNi, FeCoPt, and CoPdPt, and wherein the plurality of storage layers comprises a segregant selected from a group consisting of B, C, SiC, BC, TiC, TaC, BN, SiN, TiN, SiO₂, B₂O₃, WO₃, Ta₂O₅, and TiO₂.

12. The heat assisted media recording of claim 10, wherein a material of the first write layer is selected from a group consisting of CoPtX and CoFePtX, wherein X is selected from a group consisting of Ta, B, Mo, Si, Cu, Ag, Au, Ge, Hf, Zr, Ti, V, W, Fe, Ni, Cr, Oxide, and Ru, and wherein the first write layer comprises a segregant selected from a group consisting of B, C, SiC, BC, TiC, TaC, BN, SiN, TiN, SiO₂, B₂O₃, WO₃, Ta₂O₅, and TiO₂, and wherein a material of the second write layer is different from the material of the first write layer and is selected from a group consisting of CoPtX and CoFePtX, wherein X is selected from a group consisting of Ni, Cr, Oxide, and Ru, and wherein the second write layer comprises a segregant selected from a group consisting of B, C, SiC, BC, TiC, TaC, BN, SiN, TiN, SiO₂, B₂O₃, WO₃, Ta₂O₅, and TiO₂.

13. The heat assisted media recording of claim 10 further comprising:
a break layer disposed between the first write layer and the second write layer, wherein the break layer is nonmagnetic and wherein the break layer includes FeX, wherein X is selected from a group consisting of Co, Cr, Oxide, Nitride, C and B.

14. The heat assisted media recording of claim 13, wherein a composition of the first write layer is the same as a composition of the second write layer.

15. The heat assisted media recording of claim 10, wherein the first write layer comprises a CoPt based alloy, wherein Co comprises more than 30% of the CoPt based alloy and wherein Pt comprises greater than 0% and less than 25% of the CoPt based alloy.

16. The heat assisted media recording of claim 10, wherein the first write layer has a face-centered cubic (fcc) lattice structure or a hexagonal close packing lattice structure.

17. The heat assisted media recording of claim 10, wherein a thickness of the first write layer is different from a thickness of a second write layer.

18. A method comprising:
depositing a first granular storage layer, wherein the first storage layer is magnetic and has an L1₀ crystalline structure;
depositing a second granular storage layer over the first granular storage layer, wherein depositing the first granular storage layer and depositing the second granular storage layer occurs at over 500° C., and wherein the second storage layer is magnetic and has an L1₀ crystalline structure; and
depositing a first write layer directly over the second granular storage layer, at less than 450° C., wherein the first write layer is magnetic and has a crystalline structure that is different from the L1₀ crystalline structure of the first and second storage layers.

19. The method of claim 18 further comprising:
depositing a second write layer over the first write layer, at less than 450° C., wherein the second write layer is magnetic and has a crystalline structure that is different from the L1₀ crystalline structure of the first and second granular storage layers.

20. The method of claim 19 further comprising depositing a break layer directly over the first write layer prior to depositing the second write layer.
